(19) United States
(12) Patent Application Publication
(10) Pub. No.: US 2002/0092401 A1
(43) Pub. Date: Jul. 18, 2002

(54) Extended range guitar

(76) Inventor: Doub Pearce, Santa Clarita, CA (US)

Correspondence Address: Joseph W. Bain, Akerman, Senterfitt, 222 Lakeview Avenue, Fourth Floor, P.O. Box 3188, West Palm Beach, FL, 33402-3188, US

(21) Appl. No.: 09/764,976

(22) Filed: Jan. 17, 2001

(51) Int. Cl. G10D 1/08

(52) U.S. Cl. 84/267

(57) ABSTRACT

A stringed musical instrument having an extended range neck and a plurality of strings can include a body. The body can have a first attaching means for attaching the plurality of strings such that the plurality of strings can be spaced above and stretched across one side of the body. Also included can be a neck extending from the body having a nut attached to an end of the neck opposite the body for aligning and supporting the plurality of strings. The plurality of strings can extend from the first attaching means across the one side of the body, along the length of the neck across the nut, and can be attached to additional attaching means. The neck can have a length such that a first fret on the neck can be located a distance greater than approximately 1.964 inches from the nut.

### CROSS REFERENCE TO RELATED APPLICATIONS

(Not Applicable)

### STATEMENT REGARDING FEDERALLY SPONSORED RESEARCH OR DEVELOPMENT

(Not Applicable)

### BACKGROUND OF THE INVENTION

1. Technical Field

This invention relates to the field of guitars, and more particularly, to six-string and bass guitars.

2. Description of the Related Art

The guitar has been in existence in one form or another for many years. Over time, the guitar family of instruments, including six string guitars and bass guitars in both acoustic and electric varieties, has become an integral part of modern music. Accordingly, the musical range of the guitar family of instruments has become firmly established. For example, the open strings of a six-string guitar are typically tuned to the notes E, A, D, G, B, and E. Similarly, the open strings of a four string bass guitar are typically tuned to E, A, D, and G one octave below the tuning of a six-string guitar.

Though the musical range of the guitar family of instruments has been established, alternative configurations have been developed in an attempt to extend the range of guitars. For example, one common approach has been to extend the upper range of the guitar by including a “cut-away” portion in the body of the guitar. The cut-away enables a player to reach notes higher in pitch on the guitar neck which are correspondingly “higher up” the guitar neck, i.e., closer to the string terminus at the bridge mounted on the guitar body.

Another approach has been the addition of extra strings. For example, five string and six string bass guitars are well known in the art. Typically, additional strings are added to extend the high range of a bass guitar. Still, however, low strings can be added to extend the low range of the guitar. For example, seven string guitars are known in the art wherein a low B string is added to the guitar and tuned an interval of a perfect fourth below the low E.

Still, disadvantages relating to additional lower pitched strings do exist. Specifically, a string capable of playing such low tones requires a thicker gauge. Though the thicker gauge makes a lower tuning possible, such strings can also result in low tones having inferior tonal clarity as compared to conventionally tuned and gauged E strings. This can be especially true regarding bass guitars.

Fret positions on the fingerboard of a guitar can be determined according to a traditional formula known as the Rule of the Eighteenth. According to the formula, the vibrating string length, i.e., the distance from the nut to the string terminus at the bridge of the guitar, is divided by 18 to locate the position of the first fret spaced from the nut corresponding to one musical half step. The remaining string length, i.e., the distance from the first fret to the string terminus at the bridge, is again divided by 18 to locate the position of the second fret. This formula can be repeated until all of the fret locations on the fingerboard are determined. A similar approach called the Rule of the Ninth can be used to locate whole steps on a guitar. Using the Rule of the Ninth, the distances are divided by 9 to determine fret locations.

### SUMMARY OF THE INVENTION

It is therefore an object of the invention provide an extended range guitar.

Another object of the invention is to provide a guitar capable of playing tones lower in pitch than a conventional guitar wherein the tones produced have an improved degree of clarity.

Another object of the invention is to provide a guitar having an extended lower range wherein the tension of the strings approximates the tension of a conventionally tuned guitar.

An extended range bass guitar according to one embodiment of the invention can include a neck portion configured so as to enable the guitar to generate notes lower in pitch than the notes ordinarily achievable on a conventional bass guitar. In particular, an extended low range can be provided by extending the scale length of the neck beyond the location traditionally occupied by a nut on a conventionally scaled bass guitar. For example, in a 34 inch scale length bass guitar, the first fret is typically located a distance of approximately 1.908 inches from the nut and the bass guitar is tuned to open E. According to the invention, a bass guitar can be characterized by an extended low range extending down to D one whole step below the low E string of a conventionally tuned bass guitar while maintaining string tensions comparable to the string tensions found on the 34 inch scale length bass guitar. Specifically, the bass guitar can have a neck portion extending beyond the location of the nut in a 34 inch scale length bass guitar by one whole step. By extrapolating the neck beyond the nut using the Rule of the Eighteenth, the bass guitar can be characterized by a wide first fret wherein the fret can be located a distance of approximately 2.142 inches from the nut resulting in a scale length of approximately 38.16 inches.

The bass guitar can have an extended range neck and a plurality of strings. The bass guitar can include a body having a first attaching means for attaching the plurality of strings such that the plurality of strings can be spaced above and stretched across one side of the body. Also included can be a neck extending from the body having a nut attached to an end of the neck opposite the body for aligning and supporting the plurality of strings. The plurality of strings can extend from the first attaching means across the one side of the body and along the length of the neck across the nut and can be attached to additional attaching means. The neck can have a length such that a first fret on the neck can be located a distance greater than approximately 1.964 inches from the nut.

More specifically, the bass guitar can have four strings tuned in open position to produce notes identified by the bass clef notes of D, the space below the first ledger line below the bass clef staff; G, the first line of the bass clef staff from the bottom; C, the second space of the bass clef staff from the bottom; and F, the fourth line of the bass clef staff from the bottom. For example, the bass guitar can have four strings tuned to the frequencies of approximately 36.708 Hz, 48.999 Hz, 65.406 Hz, and 87.307 Hz. Also included can be a double dot position marker between the first fret and a second fret. The bass guitar further can include at least one transducive element attached to the body beneath the extended plurality of strings. The bass guitar can have at least 14 frets. The frets and any additional frets can be spaced relative to the first fret using the Rule of the Eighteenth.

Another embodiment can be a bass guitar having a neck extrapolated from a 30 inch scale bass guitar characterized by an extended low range extending down to C two whole steps below the low E string of a conventionally tuned bass guitar. For example, the bass guitar can have a neck portion extending beyond the location of the nut in a 30 inch scale length bass guitar by two whole steps. By extrapolating the neck beyond the nut using the Rule of the Eighteenth, the bass guitar can be characterized by a wide first fret wherein the fret can be located a distance of approximately 2.105 inches from the nut. Notably, while providing for an extended low range, the bass guitar can maintain string tensions comparable to the string tensions found on a conventional 30 inch scale length bass guitar. The bass guitar can have an overall scale length of approximately 37.5 inches.

The bass guitar can have four strings tuned in open position to produce notes identified by the bass clef notes of C, the second ledger line below the bass clef staff; F, the space below the bass clef staff; B♭, the second line of the bass clef staff from the bottom with a flat; and E♭, the third space of the bass clef staff from the bottom with a flat. For example, the bass guitar can have four strings tuned to the frequencies of approximately 32.703 Hz, 43.654 Hz, 58.270 Hz, and 77.782 Hz. The bass guitar can have a double dot position marker between a third fret and a fourth fret. Also included can be at least one transducive element attached to the body beneath the extended plurality of strings. The bass guitar can have at least 14 frets. The frets and any additional frets can be spaced relative to the first fret using the Rule of the Eighteenth.

Another embodiment can be a bass guitar having a neck extrapolated from a 32 inch scale bass guitar characterized by an extended low range extending down to D one whole step below the low E string of a conventionally tuned bass guitar. For example, the bass guitar can have a neck portion extending beyond the location of the nut in a 32 inch scale length bass guitar by one whole step. By extrapolating the neck beyond the nut using the Rule of the Eighteenth, the bass guitar can be characterized by a wide first fret wherein the fret can be located a distance of approximately 2.016 inches from the nut. Notably, while providing for an extended low range, the bass guitar can maintain string tensions comparable to the string tensions found on a conventional 32 inch scale length bass guitar. The bass guitar can have an overall scale length of approximately 35.918 inches.

The bass guitar can have four strings tuned in open position to produce notes identified by the bass clef notes of D, the space below the first ledger line below the bass clef staff; G, the first line of the bass clef staff from the bottom; C, the second space of the bass clef staff from the bottom; and F, the fourth line of the bass clef staff from the bottom. For example, the bass guitar can have four strings tuned to the frequencies of approximately 36.708 Hz, 48.999 Hz, 65.406 Hz, and 87.307 Hz. Also included can be a double dot position marker between the first fret and a second fret. The bass guitar further can include at least one transducive element attached to the body beneath the extended plurality of strings. The bass guitar can have at least 14 frets. The frets and any additional frets can be spaced relative to the first fret using the Rule of the Eighteenth.

Another embodiment can be a bass guitar having a neck extrapolated from a 32 inch scale bass guitar characterized by an extended low range extending down to C two whole steps below the low E string of a conventionally tuned bass guitar. For example, the bass guitar can have a neck portion extending beyond the location of the nut in a 30 inch scale length bass guitar by two whole steps. By extrapolating the neck beyond the nut using the Rule of the Eighteenth, the bass guitar can be characterized by a wide first fret wherein the fret can be located a distance of approximately 2.262 inches from the nut. Notably, while providing for an extended low range, the bass guitar can maintain string tensions comparable to the string tensions found on a conventional 32 inch scale length bass guitar. The bass guitar can have an overall scale length of approximately 40.31 inches.

The bass guitar can have four strings tuned in open position to produce notes identified by the bass clef notes of C, the second ledger line below the bass clef staff; F, the space below the bass clef staff; B♭, the second line of the bass clef staff from the bottom with a flat; and E♭, the third space of the bass clef staff from the bottom with a flat. For example, the bass guitar can have four strings tuned to the frequencies of approximately 32.703 Hz, 43.654 Hz, 58.270 Hz, and 77.782 Hz. The bass guitar can have a double dot position marker between a third fret and a fourth fret. Also included can be at least one transducive element attached to the body beneath the extended plurality of strings. The bass guitar can have at least 14 frets. The frets and any additional frets can be spaced relative to the first fret using the Rule of the Eighteenth.

Another embodiment can be a six-string guitar having a neck extrapolated from a 26⅛ inch scale six-string guitar characterized by an extended low range extending down to D one whole step below the low E string of a conventionally tuned six-string guitar. For example, the six-string guitar can have a neck portion extending beyond the location of the nut in a 26⅛ inch scale length six-string guitar by one whole step. By extrapolating the neck beyond the nut using the Rule of the Eighteenth, the six-string guitar can be characterized by a wide first fret wherein the fret can be located a distance of approximately 1.645 inches from the nut. Notably, the six-string guitar can maintain string tensions comparable to the string tensions found on a conventional 26⅛ inch scale six-string guitar. The bass guitar can have an overall scale length of approximately 29.31 inches.

The six-string guitar can have an extended range neck and a plurality of strings;. The six-string guitar can include a body having a first attaching means for attaching the plurality of strings such that the plurality of strings can be spaced above and stretched across one side of the body. Also included can be a neck extending from the body having a nut attached to an end of the neck opposite the body for aligning and supporting the plurality of strings. The plurality of strings can extend from the first attaching means across the one side of the body and along the length of the neck across the nut and can be attached to additional attaching means. The neck can have a length such that a first fret on the neck is located a distance greater than approximately 1.466 inches from the nut. In that case, the scale length of the six-string guitar can be less than thirty inches.

The six-string guitar can have six strings. Each string can be tuned one whole step lower in pitch than a corresponding open string of a guitar having the conventional open string tuning of E, A, D, G, B, and E. For example, the six-string guitar can have six strings tuned to the frequencies of 73.42 Hz, 98.00 Hz, 130.81 Hz, 174.61 Hz, 220.00 Hz, and 293.66 Hz. Also included can be a double dot position marker between the first fret and a second fret. The six-string guitar further can include at least one transducive element attached to the body beneath the extended plurality of strings. The six-string guitar also can have at least 14 frets. The frets and any additional frets can be spaced relative to the first fret using the Rule of Eighteenth.

Another embodiment of the invention can be a guitar having an extended range neck and a plurality of strings. The guitar can include a body having a first attaching means for attaching the plurality of strings such that the plurality of strings can be spaced above and stretched across one side of the body. Also included can be a neck extending from the body having a nut attached to an end of the neck opposite the body for aligning and supporting the plurality of strings. The plurality of strings can extend from the first attaching means across the one side of the body and along the length of the neck across the nut and can be attached to additional attaching means. The guitar can be configured such that a ratio a/b of approximately 2.245 can be achieved by dividing (a) the distance from the first attaching means to the nut, and (b) the distance between the first attaching means to a location on the neck for playing an E note having a frequency of approximately 82.41 Hz on one of the plurality of strings, wherein the string is tuned, in the open position, to a D note having a frequency of approximately 36.708 Hz.

In another embodiment, the guitar can be configured such that a ratio a/b of approximately 2.245 can be achieved by dividing (a) the distance measured from the first attaching means to the nut, by (b) the distance measured from the first attaching means to a location on the neck identified by a location for pressing one of the plurality of strings to produce an E note. The E note can be identified by the third space from the bottom of a bass clef, wherein the one of the strings is tuned to play, in the open position, a note approximately one octave and one whole step below the E note.

In another embodiment, the guitar can be configured such that a ratio a/b of approximately 2.52 can be achieved by dividing (a) the distance from the first attaching means to the nut, and (b) the distance between the first attaching means to a location on the neck for playing an E note having a frequency of approximately 82.41 Hz on one of the plurality of strings, wherein the string is tuned, in the open position, to a C note having a frequency of approximately 32.703 Hz.

In yet another embodiment, the guitar can be configured such that a ratio a/b of approximately 2.52 can be achieved by dividing (a) the distance measured from the first attaching means to the nut, by (b) the distance measured from the first attaching means to a location on the neck identified by a location for pressing one of the plurality of strings to produce an E note. The E note can be identified by the third space from the bottom of a bass clef, wherein the one of the strings is tuned to play, in the open position, a note approximately one octave and two whole steps below the E note.

### BRIEF DESCRIPTION OF THE DRAWINGS

There are shown in the drawings embodiments of which are presently preferred, it being understood, however, that the invention is not so limited to the precise arrangements and instrumentalities shown, wherein:

FIG. 1 is a front plan view illustrating an exemplary embodiment of an extended range bass guitar.

FIG. 2 is a front plan view illustrating an exemplary embodiment of an extended range bass guitar.

FIG. 3 is a front plan view of multiple fingerboards approximating the scale length of an extended range neck configuration.

FIG. 4 is a front plan view of multiple fingerboards approximating the scale length of an extended range neck configuration.

FIG. 5 is a front plan view of multiple fingerboards approximating the scale length of an extended range neck configuration.

FIG. 6 is a front plan view of multiple fingerboards approximating the scale length of an extended range neck configuration.

### DETAILED DESCRIPTION OF THE INVENTION

The invention disclosed herein provides an extended range guitar. In particular, an extended range guitar can include a neck portion configured so as to enable the guitar to generate notes lower in pitch than the notes ordinarily achievable on the guitar, while maintaining substantially the same string tension as conventional guitars. Specifically, the neck of a conventionally scaled guitar can be extended beyond the nut by extrapolating the neck dimensions and the spacing of additional frets beyond the nut using the Rule of the Eighteenth. For example, the neck of a conventional scale length guitar can be extended by a single half step, a whole step, three half steps, or two whole steps beyond the nut allowing the open string tuning to be lowered by up to two whole steps. Notably, while providing for an extended low range, a guitar according to the invention also can generate the higher pitched notes ordinarily achievable with other conventional guitars.

The term “guitar” as used herein can refer to the entire family of guitar instruments including bass guitars and six-string guitars of both the electric and acoustic varieties. The term “bass guitar” can refer to guitars traditionally having 4 strings. For example, such guitars have a conventional open string tuning of E, A, D, and G which can be annotated using the bass clef. It should be appreciated that the term bass guitar as used herein need not be restricted to four string bass guitar configurations. For example, bass guitars can have 5, 6, and 7 string configurations wherein the additional strings can be higher pitched strings such as a B string and an E string above the G string. Alternatively, the additional strings can be low pitched strings such as a low B string below the low E string. The term “six-string guitar” as used herein can refer to non-bass guitar configurations tuned to the conventional guitar tuning of E, A, D, G, B, and E which can be annotated using the treble clef. The term “six-string guitar” is used herein solely to distinguish guitars tuned to the treble clef notes of E, A, D, G, B, and E from bass guitars. Consequently, six-string guitars are riot limited to having only six-strings, but rather can have fewer than six strings, such as 4 or 5 strings, or more than six strings. For example, six-string guitars can have an added low B string below the low E string for a total of 7 strings. Regardless of the particular string configuration, it should be appreciated that the invention is not so limited to the particular number of strings disclosed.

In describing the extended range guitar, reference will be made to conventional bass and guitar tunings of E, A, D, and G, and E, A, D, G, B, and E respectively. It should be appreciated that the reference point of the low E with regard to bass tuning can be the note on a bass guitar represented by the first ledger line below the bass clef is staff. Using an A 440 Hz tuning reference, the American standard adopted by the American Standards Association, the E note can have a frequency of approximately 41.203 Hz. With reference to guitar, the low E can be the note on the guitar represented by the space below the third ledger line below the treble clef staff. Using an A 440 Hz tuning reference, that E note can have a frequency of approximately 82.41 Hz. In any case, it should be appreciated that the actual frequency of a note can vary, depending upon whether the American Standard of A 440 Hz, or the International Standard of A 435 Hz is used. Further variation in frequency can result from minor deviations in the tuning of an instrument which can go largely unnoticed by the human ear, or alternatively, result in a more natural sound. Still, other factors such as manufacturing tolerances of an instrument, the strings, or other irregularities which fall within acceptable tolerances can result in frequency deviations from the reference notes disclosed herein. Minor deviations in frequency can be within acceptable tolerances and the embodiments disclosed herein should not be unduly restricted to the exact frequencies and frequency ranges disclosed.

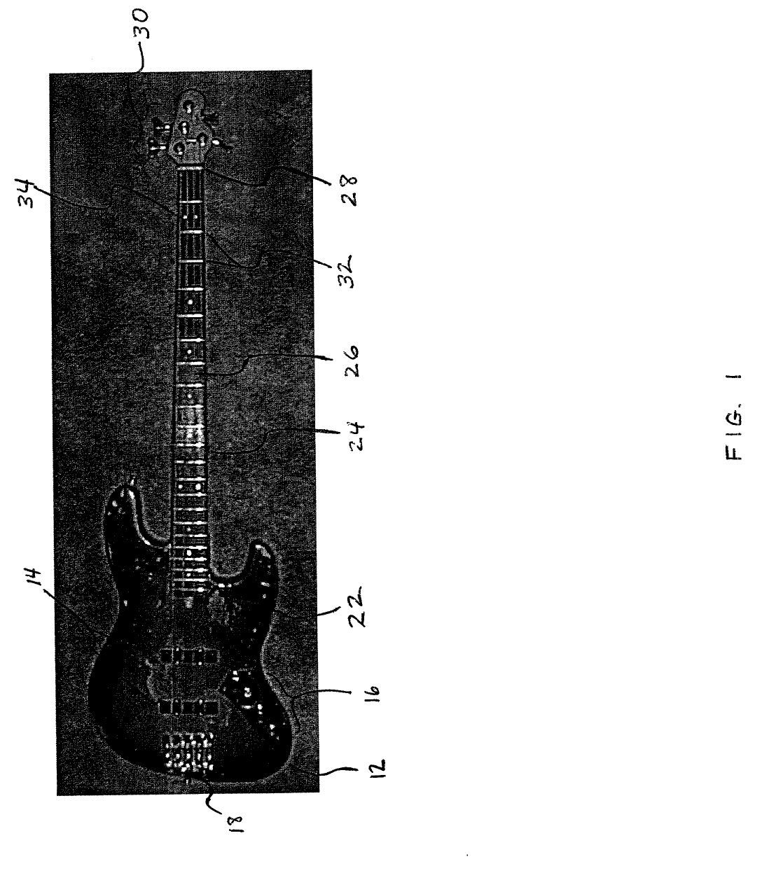

FIG. 1 is a front plan view illustrating an exemplary D tuned embodiment of a bass guitar 10 according to the invention. With reference to FIG. 1, the bass guitar can include a body 12. Notably, the body 12 can be constructed in a solid, hollow, or semi-solid body configuration. The body 12 can include one or more suitable transducive elements 14, commonly referred to as pickups. Complimentary circuitry, as well as one or more controls 16 for controlling audio parameters such as tone and volume can be included. Additional controls for determining pickup selection or for activating or deactivating one or more of the pickups also can be included.

Attached to one side of the body 12 can be an attaching means 18 for securing and spacing a plurality of strings 20 over a front face 22 of the body 12. The attaching means 18 further can elevate the plurality of strings 20 above the front face 22. The attaching means 18 can be any of a variety of bridge configurations commonly known in the art. Examples can include stop bar tailpieces, vibrato bridge configurations, tuning pegs or other tuning mechanisms adapted for use on the body of a guitar, or any other apparatus for securing a string, whether the string has a balled end or non-balled end. For example, the attaching means 18 can be a hole in the body 12 for receiving a string from the back, wherein the diameter of the hole is smaller than the balled end of the string thereby securing the string to the body. In that case the bridge configuration can include another portion for elevating and setting the intonation of the string.

The plurality of strings 20 can extend from the first attaching 18 means across the front face 22 of the body 12 and extend the length of a neck 24 along a front face 26 of the neck 24 called a fingerboard. As shown, the neck 24 can be attached to and extend outward from the body 12. Notably, the neck 24 and the body 12 can be separate components and operatively attached to one another. For example, neck 24 can be of the bolt-on neck variety or the glued on neck variety. Alternatively, neck 24 and body 12 can be substantially the same component as in the case of neck-through style construction. A nut 28 can be attached to the neck 24 for elevating the plurality of strings 20 above the neck 24. The nut 28 further can provide spacing between the plurality of strings 20. Additional attaching means 30 for securing and tuning the plurality of strings 20 can be included and attached to the end of the neck 24 opposite from the body 12. The additional attaching means 30 can be any of a variety of string securing mechanisms known in the art such as tuning pegs or any other mechanism for receiving the balled end or the non-balled end of a string. Also, the additional attaching means 30 can provide tuning functions for adjusting the pitch of the plurality of strings 20 by adjusting the tension of the strings. In any case, it should be appreciated that the invention is not so limited by the particular type of attaching means incorporated on either the body or the neck. The neck 24 can have a plurality of frets 32 attached to the fingerboard beneath the extended strings. Still, the neck 24 can be of the fretless variety.

The scale length of a guitar can be determined by the distance between the fixed end points of a vibrating string. For example, as is known in the art, scale length can be determined by measuring the distance between the nut 28 and the string terminus at the attaching means 18 or bridge on the body 12 of the guitar. It should be appreciated, however, that the actual scale length measurement of a guitar can vary from the description of the scale length offered from a manufacturer. For example, although a bass guitar can be sold as a 34 inch scale length bass guitar, the actual scale length can vary from 33⅞ inches to 34⅛ inches. The actual scale length measurements of guitars offered for sale by some manufacturers can deviate from the quoted scale lengths by as much as ¼ of an inch. Thus, the inventive arrangements disclosed herein should not be unduly restricted to the exact measurements disclosed.

Neck 24 can be an extended version of an existing scale length neck so as to provide the guitar with an extended low range. Specifically, the scale length of a conventional neck can be extrapolated beyond the location conventionally occupied by the nut such that the neck can include additional fret positions in the low register. The extrapolation can be performed using the Rule of the Eighteenth for determining half steps, the Rule of the Ninth for determining whole steps, or any other suitable method known in the art for determining the relative spacing of frets or notes on a guitar, wherein moving one fret up or down the neck produces a change in pitch of approximately one half step. For example, the bass guitar 10 of FIG. 1, can have an extended scale length of approximately 38.16 inches, extrapolated out from the conventional scale length of 34 inches, known as medium scale length. The additional length allows each string to be tuned down approximately one whole step from conventional bass tuning. As shown in FIG. 1, a double dot position marker 34 can be located in the second position of the guitar between the first and second frets. The double dot position marker 34 can denote the location on the neck 24 for playing the open string notes E, A, D, and G of a conventionally tuned bass guitar. Thus, the extrapolated additional length of the neck 24 enables the bass guitar 10 to be tuned to an open D, one whole step below the conventional tuning of a bass guitar. Notably, the extrapolated length of the bass guitar 10 allows the string tension to be maintained at the lower tuning.

It should be appreciated that the invention should not be unduly limited to the precise numerical values disclosed herein due to limitations inherent in the manufacturing process. For example, the scope of the invention should not be restricted such that minor deviations in measurements resulting from acceptable manufacturing tolerances fall outside the scope of the invention as disclosed and claimed herein.

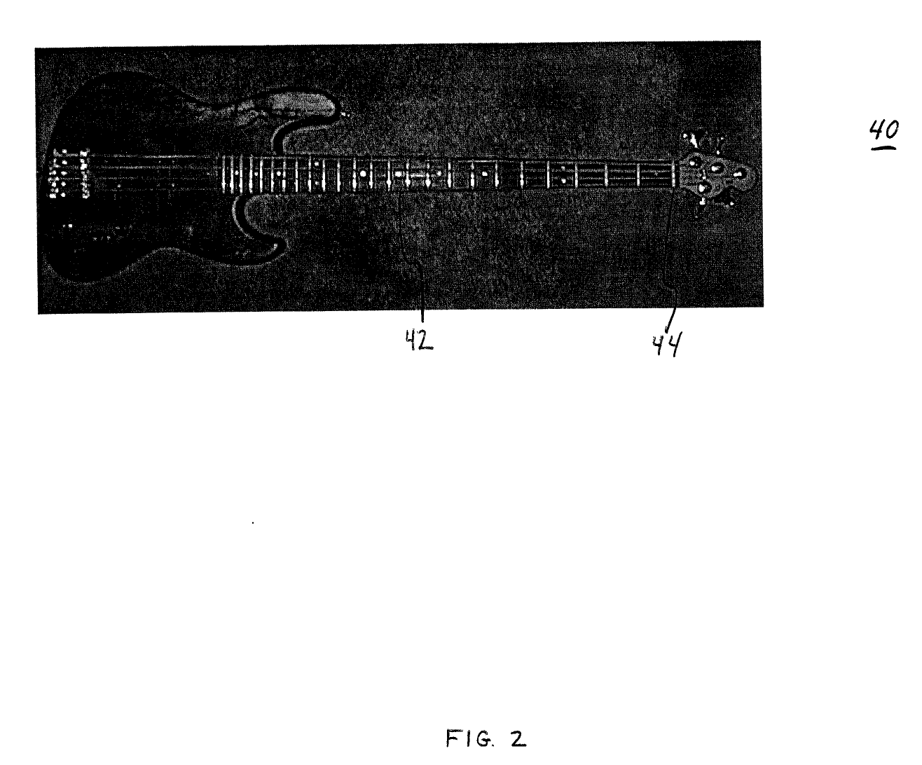

FIG. 2 is a front plan view illustrating an exemplary C tuned embodiment of a bass guitar 40 according to the invention. In that case, neck 42 can be an extended version of an existing scale length neck so as to provide the bass guitar with an extended low range. Similar to the bass guitar 10 of FIG. 1, the scale length of a conventional neck can be extrapolated beyond the location conventionally occupied by the nut 44 such that the neck 42 can include additional fret positions in the low register. The bass guitar of FIG. 2, can have an extended scale length of approximately 37.5 inches, extrapolated out from the conventional scale length of 30 inches, known as short scale length. The additional length allows each string to be tuned down approximately two whole steps from conventional bass tuning. As shown in FIG. 2, a double dot position marker 44 can be located in the fourth position of the bass guitar between the third and fourth frets. The double dot position marker 44 can denote the location on the neck for playing the open string notes E, A, D, and G of a conventionally tuned bass guitar. Thus, the extrapolated additional length of the neck enables the bass guitar 40 of FIG. 2 to be tuned to an open C, two whole steps below the conventional tuning of a bass guitar.

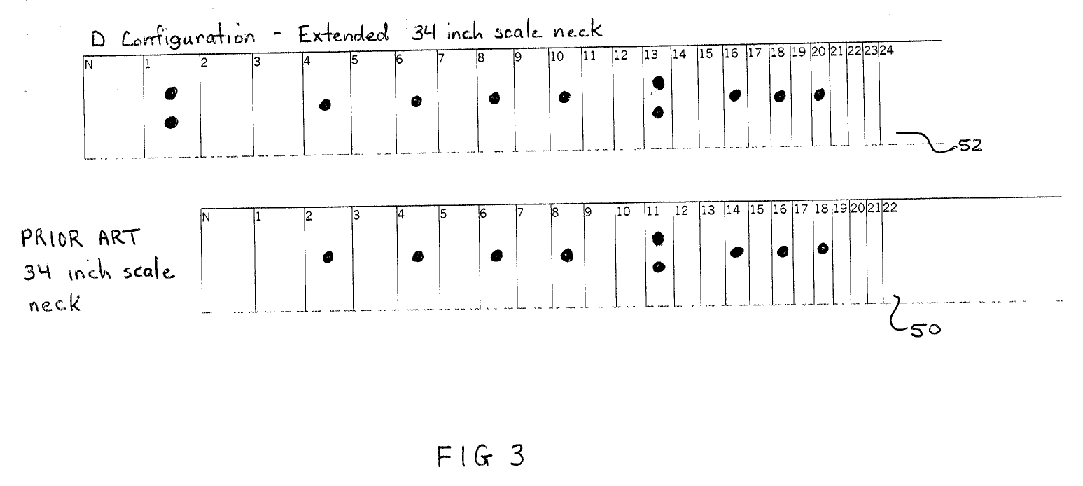

FIG. 3 is a front plan view of multiple fingerboards illustrating the relative spacing and extrapolated length of the neck of the invention of FIG. 1 as compared to the prior art. Notably, each of the scale length necks to be discussed herein can function as replacement necks for any guitar having a scale length substantially equal to the scale length from which the extended scale length is extrapolated. For example, the C and D neck configurations of FIG. 3 can replace an existing neck on a 30 inch scale length bass guitar with minor adjustments. The necks can, however, be used as replacement necks for any scale length guitar if suitable adjustments to the bridge are made in conformity with the scale length of the replacement neck.

FIG. 3 depicts a prior art 34 inch scale length neck 50 as contrasted with an exemplary scale length representation of an extrapolated D neck configuration 52. As shown, the D neck configuration length and note or fret spacing is extrapolated beyond the prior art by one whole step. The first fret and the second fret of the D configuration 52 are located approximately 2.142 inches and 4.163 inches respectively from the nut.

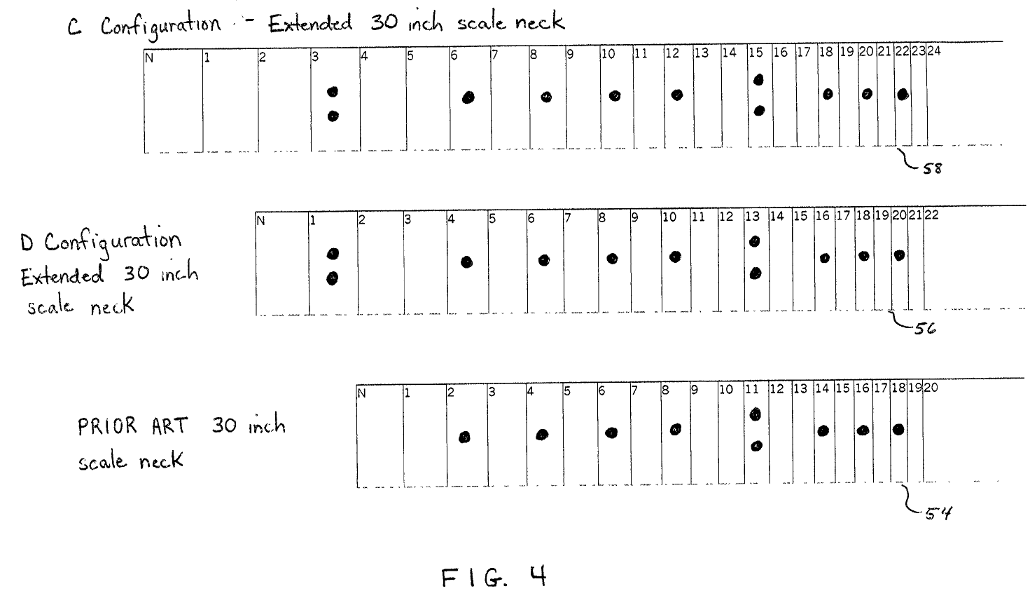

FIG. 4 is a front plan view of multiple fingerboards illustrating the relative spacing and extrapolated length of the neck of the invention of FIG. 2 as compared to the prior art. Specifically, FIG. 4 depicts a prior art 30 inch scale length neck 54 contrasted with exemplary scale length representations of an extrapolated D neck configuration 56 and the C neck configuration 58 of FIG. 2. As shown, the D configuration length and note or fret spacing is extrapolated beyond the prior art by one whole step. The C configuration is extrapolated beyond the prior art by two whole steps. As mentioned, the calculation can be performed by solving for the extended length using an equation derived from the Rule of the Eighteenth, the Rule of the Ninth, or another suitable method for determining relative fret spacing, or note spacing in the case of a fretless configuration. The first fret and the second fret of the D configuration 56 can be located approximately 1.875 inches and 3.645 inches respectively from the nut. In the case of the C configuration 58, continuing to extrapolate from the nut, the first fret and second frets can be located approximately 2.105 inches and 4.091 inches respectively from the nut.

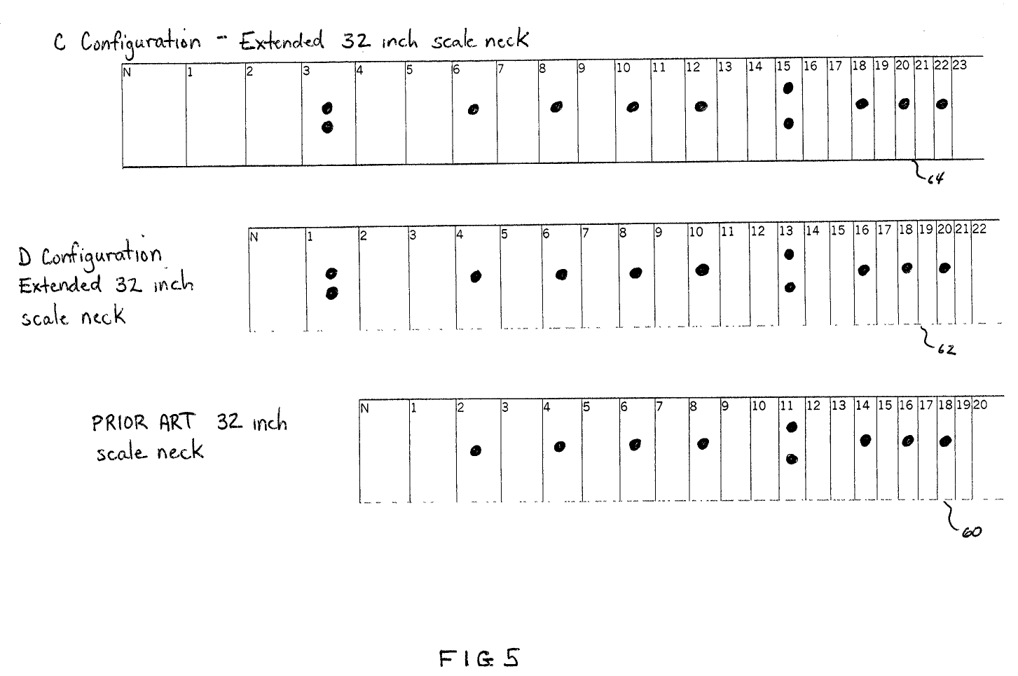

FIG. 5 is a front plan view of multiple fingerboards illustrating the relative spacing and extrapolated length of another exemplary neck configuration. FIG. 5 depicts a prior art 32 inch scale length neck 60 as contrasted with exemplary scale length representations of the extrapolated D neck configuration 62 and C neck configuration 64. As shown, the D configuration length and note or fret spacing can be extrapolated beyond the prior art by one whole step. The C configuration can be extrapolated beyond the prior art by two whole steps. The first fret and the second fret of the D configuration 62 can be located approximately 2.016 inches and 3.918 inches respectively from the nut. In the case of the C configuration 64, continuing to extrapolate from the nut, the first fret and second frets can be located approximately 2.262 inches and 4.398 inches respectively from the nut.

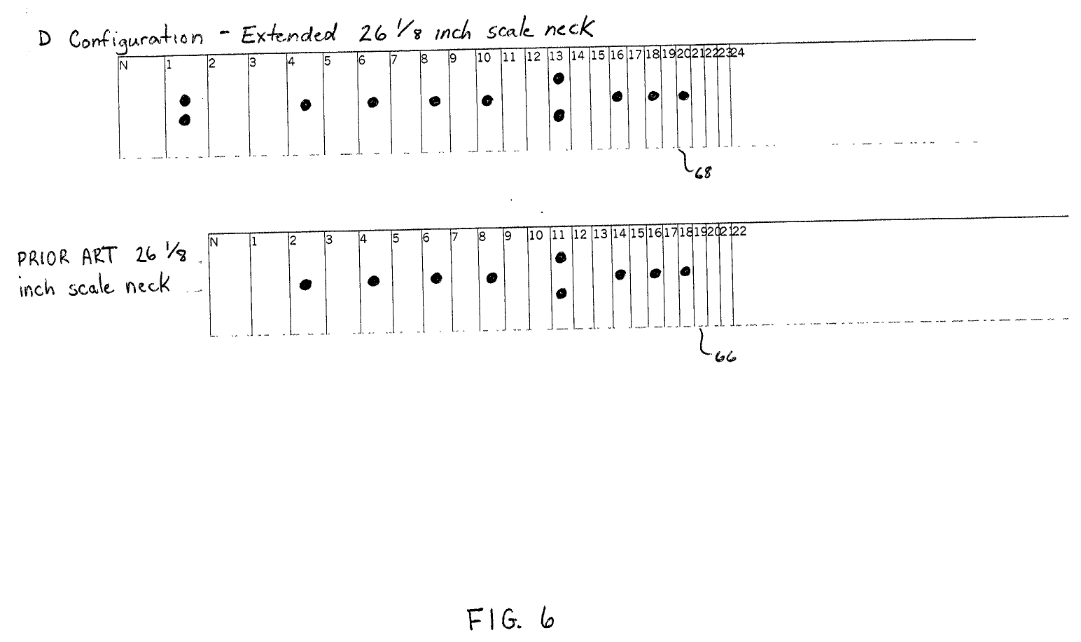

FIG. 6 is a front plan view of multiple fingerboards illustrating the relative spacing and extrapolated length of another exemplary neck configuration. FIG. 7 depicts a prior art 26⅛ inch scale length neck 66 as contrasted to an exemplary scale length representation of an extrapolated D neck configuration 68. The 26⅛ inch scale length can be a suitable starting point for six-string guitar implementations of the invention. For example, the 26⅛ inch scale length can be referred to as long classical scale length. As shown, the D neck configuration length and note or fret spacing is extrapolated beyond the prior art by one whole step. The first fret and the second fret of the D configuration 68 are located approximately 1.645 inches and 3.198 inches respectively from the nut.

What is claimed is:

1. A bass guitar having an extended range neck and a plurality of strings, said stringed musical instrument comprising:
a body, said body having a first attaching means for attaching said plurality of strings such that said plurality of strings are spaced above and stretched across one side of said body;
a neck extending from said body having a nut attached to an end of said neck opposite said body for aligning and supporting said plurality of strings, wherein said plurality of strings extend from said first attaching means across said one side of said body and along the length of said neck across said nut and are attached to additional attaching means; and
said neck having a length such that a first fret on said neck is located a distance greater than approximately 1.964 inches from said nut.

2. The bass guitar of claim 1, wherein said first fret on said neck is located a distance of approximately 2.142 inches from said nut.

3. The bass guitar of claim 2, having four strings tuned in open position to produce notes identified by the bass clef notes of D, the space below the first ledger line below the bass clef staff; G, the first line of the bass clef staff from the bottom; C, the second space of the bass clef staff from the bottom; and F, the fourth line of the bass clef staff from the bottom.

4. The bass guitar of claim 2, having four strings tuned to the frequencies of approximately 36.708 Hz, 48.999 Hz, 65.406 Hz, and 87.307 Hz.

5. The bass guitar of claim 2, having a double dot position marker between said first fret and a second fret.

6. The bass guitar of claim 2, having at least one transducive element attached to said body beneath said extended plurality of strings.

7. The bass guitar of claim 2, having at least 14 frets wherein said frets and any additional frets are spaced relative to said first fret using the Rule of the Eighteenth.

8. The bass guitar of claim 1, wherein said first fret on said neck is located a distance of approximately 2.105 inches from said nut.

9. The bass guitar of claim 8, having four strings tuned in open position to produce notes identified by the bass clef notes of C, the second ledger line below the bass clef staff; F, the space below the bass clef staff; B♭, the second line of the bass clef staff from the bottom with a flat; and E♭, the third space of the bass clef staff from the bottom with a flat.

10. The bass guitar of claim 8, having four strings tuned to the frequencies of approximately 32.703 Hz, 43.654 Hz, 58.270 Hz, and 77.782 Hz.

11. The bass guitar of claim 8, having a double dot position marker between a third fret and a fourth fret.

12. The bass guitar of claim 8, having at least one transducive element attached to said body beneath said extended plurality of strings.

13. The bass guitar of claim 8, having at least 14 frets wherein said frets and any additional frets are spaced relative to said first fret using the Rule of the Eighteenth.

14. The bass guitar of claim 1, wherein said first fret on said neck is located a distance of approximately 2.016 inches from said nut.

15. The bass guitar of claim 14, having four strings tuned in open position to produce notes identified by the bass clef notes of D, the space below the first ledger line below the bass clef staff; G, the first line of the bass clef staff from the bottom; C, the second space of the bass clef staff from the bottom; and F, the fourth line of the bass clef staff from the bottom.

16. The bass guitar of claim 14, having four strings tuned to the frequencies of approximately 36.708 Hz, 48.999 Hz, 65.406 Hz, and 87.307 Hz.

17. The bass guitar of claim 14, having a double dot position marker between said first fret and a second fret.

18. The bass guitar of claim 14, having at least one transducive element attached to said body beneath said extended plurality of strings.

19. The bass guitar of claim 14, having at least 14 frets wherein said frets and any additional frets are spaced relative to said first fret using the Rule of the Eighteenth.

20. The bass guitar of claim 1, wherein said first fret on said neck is located a distance of approximately 2.262 inches from said nut.

21. The bass guitar of claim 20, having four strings tuned in open position to produce notes identified by the bass clef notes of C, the second ledger line below the bass clef staff; F, the space below the bass clef staff; B♭, the second line of the bass clef staff from the bottom with a flat; and E♭, the third space of the bass clef staff from the bottom with a flat.

22. The bass guitar of claim 20, having four strings tuned to the frequencies of approximately 32.703 Hz, 43.654 Hz, 58.270 Hz, and 77.782 Hz.

23. The bass guitar of claim 20, having a double dot position marker between a third fret and a fourth fret.

24. The bass guitar of claim 20, having at least one transducive element attached to said body beneath said extended plurality of strings.

25. The bass guitar of claim 20, having at least 14 frets wherein said frets and any additional frets are spaced relative to said first fret using the Rule of the Eighteenth.

26. A six-stringed guitar having an extended range neck and a plurality of strings, said stringed musical instrument comprising:
a body, said body having a first attaching means for attaching said plurality of strings such that said plurality of strings are spaced above and stretched across one side of said body;
a neck extending from said body having a nut attached to an end of said neck opposite said body for aligning and supporting said plurality of strings, wherein said plurality of strings extend from said first attaching means across said one side of said body and along the length of said neck across said nut and are attached to additional attaching means; and
said neck having a length such that a first fret on said neck is located a distance greater than approximately 1.466 inches from said nut, wherein the scale length of said stringed musical instrument is less than thirty inches.

27. The six-string guitar of claim 26, wherein said first fret on said neck is located a distance of approximately 1.645 inches from said nut.

28. The six-string guitar of claim 26, having six strings, wherein each said string is tuned one whole step lower in pitch than a corresponding open string of a guitar having the conventional open string tuning of E, A, D, G, B, E.

29. The six-string guitar of claim 26, having six strings tuned to the frequencies of 73.42 Hz, 98.00 Hz, 130.81 Hz, 174.61 Hz, 220.00 Hz, and 293.66 Hz.

30. The six-string guitar of claim 26, having a double dot position marker between said first fret and a second fret.

31. The six-string guitar of claim 26, having at least one transducive element attached to said body beneath said extended plurality of strings.

32. The six-string guitar of claim 26, having at least 14 frets wherein said frets and any additional frets are spaced relative to said first fret using the Rule of the Eighteenth.

33. A guitar having an extended range neck and a plurality of strings, said stringed musical instrument comprising:
a body, said body having a first attaching means for attaching said plurality of strings such that said plurality of strings are spaced above and stretched across one side of said body;
a neck extending from said body having a nut attached to an end of said neck opposite said body for aligning and supporting said plurality of strings, wherein said plurality of strings extend from said first attaching means across said one side of said body and along the length of said neck across said nut and are attached to additional attaching means; and
wherein a ratio a/b is approximately 2.245, said ratio is achieved by dividing (a) the distance from said first attaching means to said nut, and (b) the distance between said first attaching means to a location on said neck for playing an E note having a frequency of approximately 82.41 Hz on one of said plurality of strings, wherein said string is tuned, in the open position, to a D note having a frequency of approximately 36.708 Hz.

34. A guitar having an extended range neck and a plurality of strings, said stringed musical instrument comprising:
a body, said body having a first attaching means for attaching said plurality of strings such that said plurality of strings are spaced above and stretched across one side of said body;
a neck extending from said body having a nut attached to an end of said neck opposite said body for aligning and supporting said plurality of strings, wherein said plurality of strings extend from said first attaching means across said one side of said body and along the length of said neck across said nut and are attached to additional attaching means; and
wherein a ratio a/b is approximately 2.245, said ratio is achieved by dividing (a) the distance measured from said first attaching means to said nut, by (b) the distance measured from said first attaching means to a location on said neck identified by a location for pressing one of said plurality of strings to produce an E note, said E note identified by the third space from the bottom of a bass clef, wherein said one of said strings is tuned to play, in the open position, a note approximately one octave and one whole step below said E note.

35. A guitar having an extended range neck and a plurality of strings, said stringed musical instrument comprising:
a body, said body having a first attaching means for attaching said plurality of strings such that said plurality of strings are spaced above and stretched across one side of said body;
a neck extending from said body having a nut attached to an end of said neck opposite said body for aligning and supporting said plurality of strings, wherein said plurality of strings extend from said first attaching means across said one side of said body and along the length of said neck across said nut and are attached to additional attaching means; and
wherein a ratio a/b is approximately 2.52, said ratio is achieved by dividing (a) the distance from said first attaching means to said nut, and (b) the distance between said first attaching means to a location on said neck for playing an E note having a frequency of approximately 82.41 Hz on one of said plurality of strings, wherein said string is tuned, in the open position, to a C note having a frequency of approximately 32.703 Hz.

36. A guitar having an extended range neck and a plurality of strings, said stringed musical instrument comprising:
a body, said body having a first attaching means for attaching said plurality of strings such that said plurality of strings are spaced above and stretched across one side of said body;
a neck extending from said body having a nut attached to an end of said neck opposite said body for aligning and supporting said plurality of strings, wherein said plurality of strings extend from said first attaching means across said one side of said body and along the length of said neck across said nut and are attached to additional attaching means; and
wherein a ratio a/b is approximately 2.52, said ratio is achieved by dividing (a) the distance measured from said first attaching means to said nut, by (b) the distance measured from said first attaching means to a location on said neck identified by a location for pressing one of said plurality of strings to produce an E note, said E note identified by the third space from the bottom of a bass clef, wherein said one of said strings is tuned to play, in the open position, a note approximately one octave and two whole steps below said E note.
